(19) United States
(12) Patent Application Publication
(10) Pub. No.: US 2018/0354744 A1
(43) Pub. Date: Dec. 13, 2018

(54) LINE FIXING DEVICE

(71) Applicants: SANG WON NOH, SEOUL (KR); AE RAN LEE, SEOUL (KR)

(72) Inventors: SANG WON NOH, SEOUL (KR); AE RAN LEE, SEOUL (KR)

(21) Appl. No.: 16/046,310

(22) Filed: Jul. 26, 2018

Related U.S. Application Data
(63) Continuation of application No. PCT/KR2017/000941, filed on Jan. 26, 2017.

(30) Foreign Application Priority Data
Jan. 29, 2016 (KR) 10-2016-0011500

(51) Int. Cl. B65H 75/14; B65H 75/26; B65H 75/44; H01R 13/60; H02G 11/02

(52) U.S. Cl. CPC B65H 75/14; B65H 75/26; H04R 1/1033; H01R 13/60; H02G 11/02; B65H 75/4473

(57) ABSTRACT

A line fixing device includes a first housing, a second housing disposed to face the first housing, and a fixing member at least partially provided between the first housing and the second housing and configured to hold and fix a line. The fixing member includes a base portion, a column portion, protruding from a center of the base portion, around which the line is to be wound, and a plurality of latching protrusions disposed at predetermined intervals along an outer periphery of the base portion and configured to hold and fix a portion of the line which is not wound around the column portion. The latching protrusions have a tapered shape with a diameter gradually decreasing away from the base portion.

### CROSS-REFERENCE TO RELATED APPLICATIONS

The present application is a continuation of International Patent Application No. PCT/KR2017/000941, filed on Jan. 26, 2017, which claims priority to and benefit of Korean Patent Application No. 10-2016-0011500, filed on Jan. 29, 2016. The disclosures of the above-listed applications are hereby incorporated by reference herein in their entirety.

### TECHNICAL FIELD

The present disclosure relates to a line fixing device.

### BACKGROUND

Generally, various devices for receiving data through a wire or in a wireless manner are required to use an electronic device.

Meanwhile, in the case of an electronic device that needs to receive data through a wire, or otherwise cannot wirelessly receive data, a line is essentially used. Such a line is manufactured to have a predetermined length based on the distance between the electronic device and the user.

However, the environment of a user who uses an electronic device can be diverse and there are limitations in manufacturing a line to meet the diverse environments of the user. Thus, a problem is posed in that the user has to personally adjust the length of the line as necessary.

### SUMMARY

Embodiments of the present disclosure provide a line fixing device capable of adjusting the length of a line such as a charger line, an earphone line, a headphone line, an electric wire, a cable, a telephone line or the like to be suitable for use, and capable of stably holding and fixing an unused line.

In accordance with an aspect, there is provided a line fixing device including: a first housing; a second housing disposed to face the first housing; and a fixing member at least partially provided between the first housing and the second housing and configured to hold and fix a line.

The fixing member may include a base portion, a column portion, protruding from a center of the base portion, around which the line is to be wound, and a plurality of latching protrusions disposed at predetermined intervals along an outer periphery of the base portion and configured to hold and fix a portion of the line that is not wound around the column portion.

A bent portion bent in a “C”-like shape may be formed in an end portion of the fixing member, and the first housing may be fitted to the bent portion of the fixing member.

The fixing member may be made of at least one of a silicon material, a urethane material and a rubber material.

The latching protrusions may have a diameter gradually decreasing away from the base portion.

The latching protrusions may be disposed in a plurality of arrays spaced apart at predetermined intervals between the column portion and an edge of the base portion, the latching protrusions disposed in the outermost array may have a height greater than that of the latching protrusions disposed in the innermost array, and the latching protrusions disposed in a middle array between the outermost array and the innermost array may have a height smaller than that of the latching protrusions disposed in the outermost array and greater than that of the latching protrusions disposed in the innermost array.

The line fixing device may further include: a first adhesive member attached to a lower surface of the first housing; and a second adhesive member attached to a lower surface of the second housing.

Embodiments of the present disclosure are capable of adjusting the length of a line such as a charger line, an earphone line, a headphone line, an electric wire, a cable, a telephone line or the like to be suitable for use, and are capable of stably holding and fixing an unused line.

### BRIEF DESCRIPTION OF THE DRAWINGS

FIG. 1 is a perspective view illustrating a line fixing device according to an embodiment of the present disclosure.

FIG. 2 is an exploded perspective view of the line fixing device shown in FIG. 1.

FIG. 3 is a sectional view taken along line II-III′ in FIG. 1.

FIG. 4 is a perspective view showing an example in which the line fixing device shown in FIG. 1 is used.

FIG. 5 is a perspective view of another example in which the line fixing device shown in FIG. 1 is used.

FIG. 6 is a perspective view illustrating a line fixing device according to another embodiment of the present disclosure.

FIG. 7 is an exploded perspective view of the line fixing device line fixture shown in FIG. 6.

FIG. 8 is a sectional view taken along line VII-VII′ in FIG. 6.

FIG. 9 is a perspective view showing an example in which the line fixing device shown in FIG. 6 is used.

FIG. 10 is a perspective view showing another example in which the line fixing device shown in FIG. 6 is used.

### DETAILED DESCRIPTION

Hereinafter, configurations and operations of embodiments will be described in detail with reference to the accompanying drawings. The following description is one of various patentable aspects of the present disclosure and may form a part of the detailed description of the present disclosure.

However, in describing the present disclosure, detailed descriptions of known configurations or functions that make the present disclosure obscure may be omitted.

The present disclosure may be modified and include various embodiments. Specific embodiments will be exemplarily illustrated in the drawings and described in the detailed description of the embodiments. However, it should be understood that they are not intended to limit the present disclosure to specific embodiments but rather to cover all modifications, similarities, and alternatives that are included in the spirit and scope of the present disclosure.

The terms used herein, including ordinal numbers such as “first” and “second” may be used to describe, and not to limit, various components. The terms simply distinguish the components from one another.

When it is said that a component is “connected” or “linked” to another component, it should be understood that the former component may be directly connected or linked to the latter component or a third component may be interposed between the two components.

Specific terms in the present disclosure are used simply to describe specific embodiments without limiting the present disclosure. An expression used in the singular encompasses the expression of the plural, unless it has a clearly different meaning in the context.

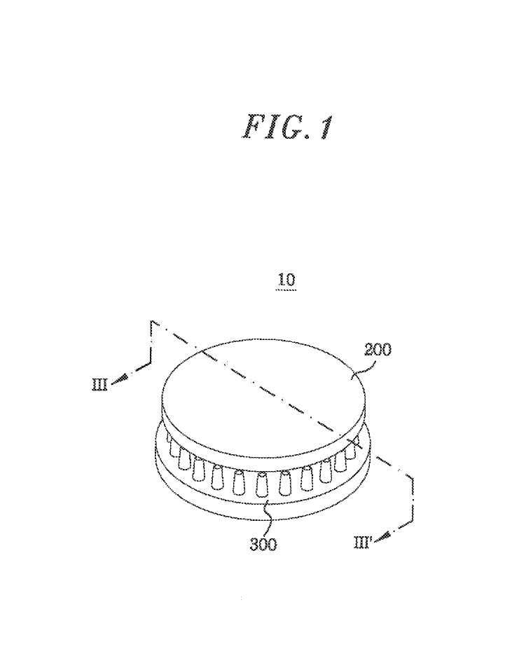

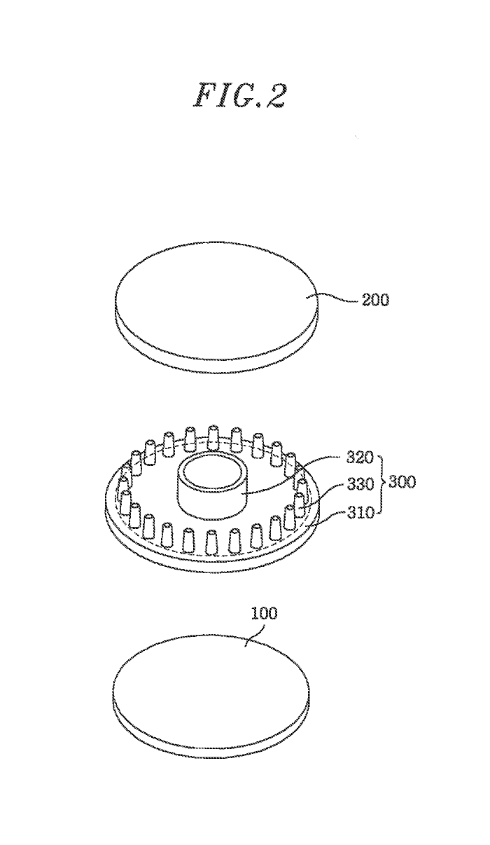

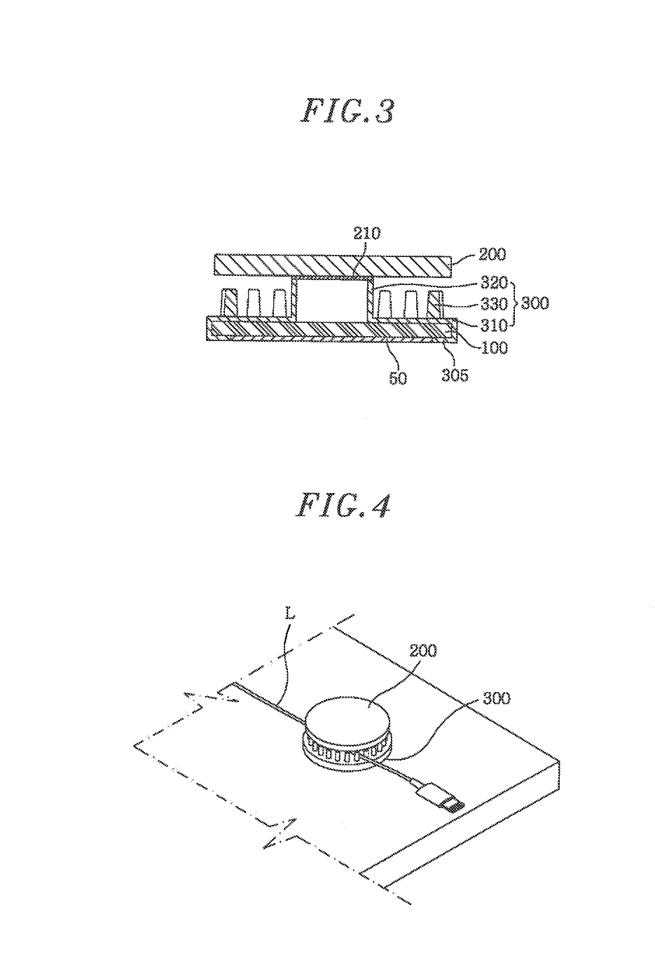

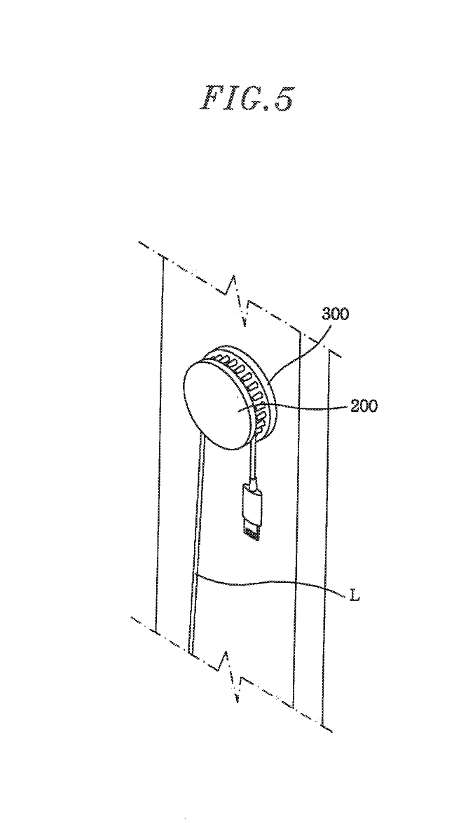

FIG. 1 is a perspective view illustrating a line fixing device according to an embodiment of the present disclosure. FIG. 2 is an exploded perspective view of the line fixing device shown in FIG. 1. FIG. 3 is a sectional view taken along line III-III′ in FIG. 1. FIG. 4 is a perspective view showing an example in which the line fixing device shown in FIG. 1 is used. FIG. 5 is a perspective view of another example in which the line fixing device shown in FIG. 1 is used.

Referring to FIGS. 1 to 5, the line fixing device 10 according to an embodiment of the present disclosure may include a first housing 100, a second housing 200 opposed to the first housing 100, and a fixing member 300 at least partially provided between the first housing 100 and the second housing 200 and configured to hold and fix a line L.

The fixing member 300 may be provided on the first housing 100. For example, the first housing 100 may be formed of a polymeric material or an acrylic material having predetermined durability and may have a circular plate shape.

In addition, a first adhesive member 50 may be attached to the lower surface of the first housing 100. This enables the user to mount the first housing 100 in a desired place. However, this is nothing more than an example. A separate clip (not shown) may be attached to the lower surface of the first housing 100 so that the first housing 100 can be fixed to a desired place (e.g., a user's clothes, a bag, etc.). This makes it possible to enhance the portability of the line fixing device 10.

In this case, the first adhesive member 50 may be formed to have a thickness corresponding to the step difference which may occur between the first housing 100 and the fixing member 300. This will be described later.

The second housing 200 may be disposed to face the first housing 100. The second housing 200 covers the fixing member 300 to prevent the fixing member 300 from being contaminated or damaged. A second adhesive member 210 is provided in the portion where the second housing 200 and the fixing member 300 make contact with each other. Thus, the second housing 200 and the fixing member 300 may be firmly connected to each other.

The connection of the second housing 200 and the fixing member 300 is not limited thereto. An insertion groove (not shown) corresponding to a column portion 320 of the fixing member 300 may be separately formed in the second housing 200 so that the second housing 210 and the fixing member 300 can be connected to each other.

Meanwhile, various designs such as a character, a brand name, a pattern, a symbol, a letter and the like may be printed on the upper surface of the second housing 200.

In addition, the second housing 200 may be formed of substantially the same material as the first housing 100 and may have a circular shape. However, if it is desired to print various designs such as a character, a brand name, a pattern, a symbol, a letter and the like on the upper surface of the second housing 200, the second housing 200 may be made of an easily printable material.

In addition, a near-field communication (NFC) chip may be attached to the upper surface of the second housing 200. This enables the line fixing device 10 to provide various services based on short-range wireless communication.

In this embodiment, the first housing 100 and the second housing 200 have a circular shape. However, the spirit of the present disclosure is not limited thereto. The first housing 100 and the second housing 200 may be modified to have various shapes such as a square shape, a rectangular shape, a triangular shape and the like.

The fixing member 300 may be at least partially provided between the first housing 100 and the second housing 200 to hold and fix a line L.

In this case, the fixing member 300 may be provided at its end portion with a structure (hereinafter referred to as a bent portion 305) which is bent in a “C”-like shape. The first housing 100 may be fitted to a “C”-like groove portion (not shown) defined by the bent portion 305. When the first housing 100 is fitted into the groove portion of the fixing member 300, a step difference may be generated between the remaining portion of the first housing 100 other than the edge portion of the first housing 100 fitted into the groove portion of the fixing member 300 and the fixing member 300. Thus, the first adhesive member 50 having a thickness corresponding to the step difference may be attached to the lower surface of the remaining portion of the first housing 100 other than the edge portion of the first housing 100 fitted into the groove portion of the fixing member 300, thereby eliminating the step difference. However, this is nothing more than an example. The fixing member 300 may be attached to the upper surface of the first housing 100.

At this time, the lateral sides of the fixing member 300 are all opened. Thus, the user may insert and fix the line L in the fixing member 300 in a desired orientation.

The fixing member 300 includes a base portion 310, a column portion 320 protruding from the center of the base portion 310 so that the line L can be wound around the column portion 320, and a plurality of latching protrusions 330 disposed at predetermined intervals along the outer periphery of the base portion 310 and configured to hold and fix a portion of the line L which is not wound around the column portion 320.

The column portion 320 and the latching protrusions 330 may be provided on the base portion 310.

The column portion 320 may protrude from the center of the base portion 310 so that the line L can be wound around the column portion 320. At this time, the column portion 320 may be formed integrally with the base portion 310. However, this is nothing more than an example. The column portion 320 may be separately manufactured and then attached to the center of the base portion 310. The line L may be wound around the column portion 320. The user may wind the line L around the column portion 320 to reduce the length of the line L. This makes it possible to use the line L in a convenient manner.

The latching protrusions 330 may be disposed at predetermined intervals along the outer periphery of the base portion 310. At this time, the latching protrusions 330 may be integrally formed with the base portion 310 or may be separately manufactured and then attached at a predetermined interval along the outer periphery of the base portion 310.

As described above, the latching protrusions 330 are disposed at predetermined intervals along the outer periphery of the base portion 310. The line L may be inserted and fixed in the gap between the adjacent latching protrusions 330. In this case, the diameter of the latching protrusions 330 may have a tapered shape. For example, the diameter of the latching protrusions 330 may become smaller away from the base portion 310. Thus, the distance between the adjacent latching protrusions 330 may grow larger away from the base portion 310.

In other words, the holding efficiency of the line L may be improved in the region where the gap between the adjacent latching projections 330 is narrow, and the insertion or separation efficiency of the line L may be improved in the region where the gap between the adjacent latching protrusions 330 becomes wider away from the base portion 310. As used herein, the term “separation of the line L” means that the user removes the line L inserted and fixed between the adjacent latching protrusions 330.

Meanwhile, the fixing member 300 may be made of a silicon material, a urethane material, a rubber material or the like having a predetermined frictional force and a predetermined restoring force. Accordingly, it is possible to prevent a phenomenon that the line L wound around the column portion 320 is loosened and the line L inserted and fixed between the adjacent latching protrusions 330 is separated.

As described above, the movement of the line L inserted and fixed between the adjacent latching projections 330 is prevented by the frictional force of the latching protrusions 330. Thus, the length L of the line L inserted and fixed between the adjacent latching projections 330 may not vary. In other words, unless the user pulls the line L from the latching protrusions 330 to reuse the line L, the line L may be kept in an inserted and fixed state between the latching protrusions 330 without the length of the line L being changed.

Depending on the use environment, the user may merely insert and fix the line L to the fixing member 300 in a straight line shape as shown in FIG. 4. Alternatively, the line L may be inserted and fixed to the fixing member 300 by turning the line L at least once in one direction as shown in FIG. 5. Although not shown, a plurality of lines L may be inserted and fixed to the fixing member 300 at the same time.

In addition, as described above, the latching protrusions 330 are made of a silicon material, a urethane material or a rubber material so as to have a predetermined restoring force. Therefore, when the line L is caught between the adjacent latching protrusions 330, it is possible to smoothly insert and fix the line L between the adjacent latching protrusions 330 by reducing the resistance between the line L and the latching protrusions 330. The fixing efficiency of the line L can be improved regardless of the thickness of the line L.

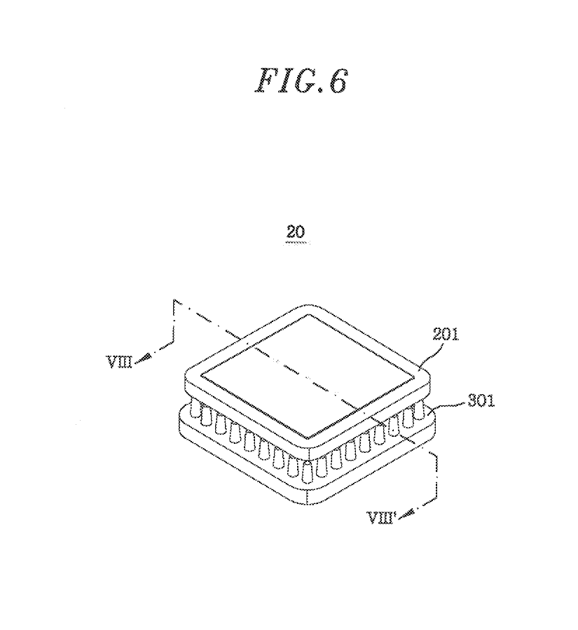

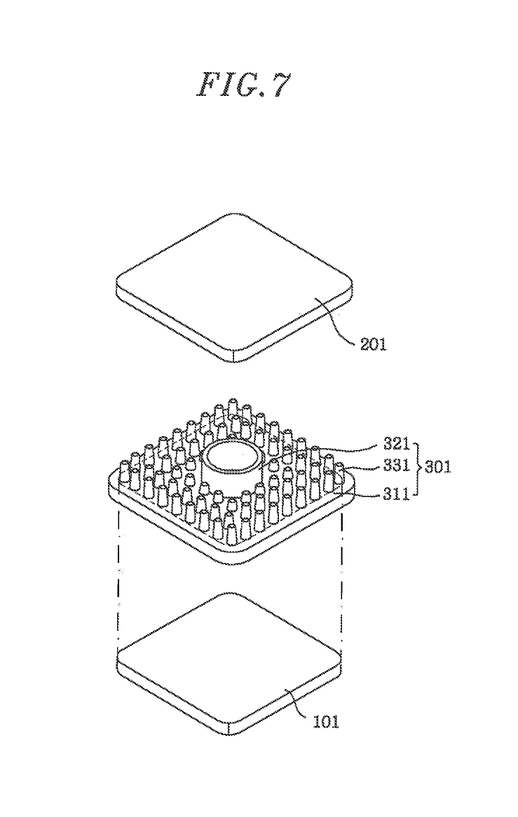

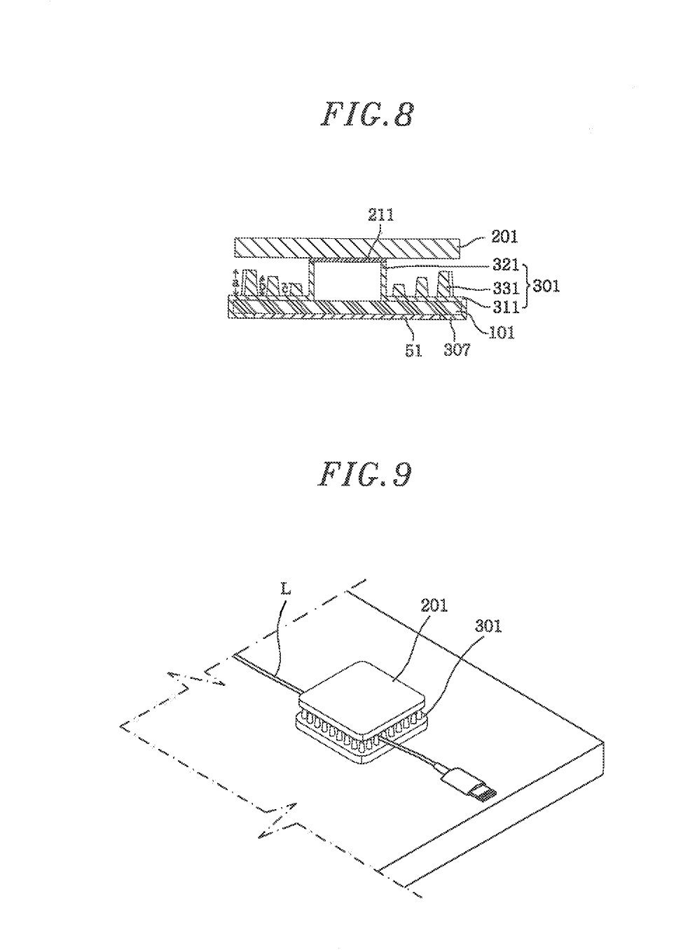

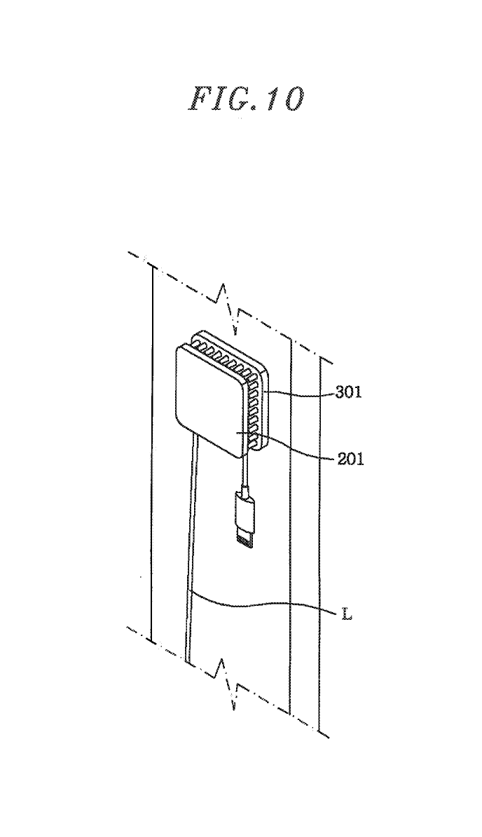

Hereinafter, a line fixing device 20 according to another embodiment of the present disclosure will be described with reference to FIGS. 6 to 10. FIG. 6 is a perspective view illustrating a line fixing device according to another embodiment of the present disclosure. FIG. 7 is an exploded perspective view of the line fixing device shown in FIG. 6. FIG. 8 is a sectional view taken along line VIII-VIII′ in FIG. 6. FIG. 9 is a perspective view showing an example in which the line fixing device shown in FIG. 6 is used. FIG. 10 is a perspective view showing another example in which the line fixing device shown in FIG. 6 is used.

Referring to FIGS. 6 to 10, the line fixing device 20 according to another embodiment of the present disclosure may include a first housing 101, a second housing 201 and a fixing member 301.

The fixing member 301 may be provided on the first housing 101. The first housing 101 may have a square shape. Therefore, as compared with the first housing 100 of the line fixing device 10 described with reference to FIGS. 1 to 5, the first housing 101 may have a large surface area. Accordingly, when the user attaches a first adhesive member 51 to the lower surface of the first housing 101 and mounts the first housing 101 to a place where the line fixing device 20 is to be used, it is possible to further enhance the stability of use.

The second housing 201 may be disposed to face the first housing 101. A second adhesive member 211 is provided in the portion where the second housing 201 and the column portion 321 of the fixing member 301 make contact with each other. Thus, the second housing 201 and the fixing member 301 may be firmly connected to each other.

However, the connection relationship between the second housing 201 and the fixing member 301 is not limited thereto. An insertion groove (not shown) corresponding to the column portion 321 of the fixing member 301 may be separately formed in the second housing 201 to connect the second housing 201 and the fixing member 301.

The second housing 201 has a square shape which is substantially the same as the shape of the first housing 101. Therefore, as compared with the second housing 200 of the line fixing device 10 described with reference to FIGS. 1 to 5, the second housing 201 has a large surface area. It is therefore possible to further reduce the contamination, damage and the like of the fixing member 301.

In the present embodiment, the first housing 101 and the second housing 201 have a square shape. However, the spirit of the present disclosure is not limited thereto. The first housing 101 and the second housing 201 may be modified to have various shapes such as a rectangular shape, a triangular shape and the like.

The fixing member 301 may be at least partially provided between the first housing 101 and the second housing 201 to hold and fix a line L.

In this case, the fixing member 301 may be provided at its end portion with a structure (hereinafter referred to as a bent portion 307) which is bent in a “C”-like shape. The first housing 101 may be fitted to a “C”-like groove portion (not shown) defined by the bent portion 307. When the first housing 101 is fitted into the groove portion of the fixing member 301, a step difference may be generated between the remaining portion of the first housing 101 other than the edge portion of the first housing 101 fitted into the groove portion of the fixing member 301. Thus, the first adhesive member 51 having a thickness corresponding to the step difference may be attached to the lower surface of the remaining portion of the first housing 101 other than the edge portion of the first housing 101 fitted into the groove portion of the fixing member 301, thereby eliminating the step difference. However, this is nothing more than an example. The fixing member 301 may be attached to the upper surface of the first housing 101.

At this time, the side surfaces of the fixing member 301 are all opened. Thus, the user may insert and fix the line L in the fixing member 301 in a desired orientation.

The fixing member 301 includes a base portion 311, a column portion 321 protruding from the center of the base portion 311 so that the line L can be wound around the column portion 321, and a plurality of latching protrusions 331 disposed at predetermined intervals along the outer periphery of the base portion 311 and configured to hold and fix a portion of the line L which is not wound around the column portion 321.

The column portion 321 and the latching protrusions 331 may be provided on the base portion 311.

The line L may be wound around the column portion 321. At this time, the user may neatly arrange the line L by winding the line L on the column portion 321 as much as he wants to reduce the length of the line L.

The latching protrusions 331 may be disposed over the region between the column portion 321 of the fixing member 301 and the edge of the fixing member 301. The portion of the line L which is not wound around the column portion 321 may be inserted and fixed between the latching protrusions 331. For example, the latching protrusions 331 may be formed of a silicon material, a urethane material or the like having a predetermined restoring force, a predetermined frictional force and the like. Therefore, it is possible to prevent the unwinding of the line L wound on the column portion 321 and the movement of the line L inserted and fixed between the adjacent latching projections 331. In addition, the line L having a large thickness may be inserted and fixed by the restoring force of the latching protrusion 331.

Just like the latching protrusions 330 of the line fixing device 10 described with reference to FIGS. 1 to 5, the diameter of the latching protrusions 331 of the present embodiment may become smaller away from the base portion 311. This has been described above and, therefore, redundant description will be omitted.

However, unlike the latching protrusions 330 described with reference to FIGS. 1 to 5, the latching protrusions 331 of the present embodiment may be arranged in a plurality of arrays spaced apart at predetermined intervals between the column portion 321 and the edge of the base portion 311. In this arrangement, the height of the latching protrusions 331 may gradually increase as it goes to the edge of the base portion 311.

More specifically, the height “a” of the latching protrusions 331 disposed in the outermost array on the fixing member 301 is substantially larger than the height “c” of the latching protrusions 331 disposed in the innermost array on the fixing member 301. The height “b” of the latching protrusions 331 disposed in the middle array between the outermost array and the innermost array may be substantially smaller than the height “a” of the latching protrusions 331 disposed in the outermost array and may be larger than the height “c” of the latching protrusions 331 disposed in the innermost array.

This makes it possible to prevent the line L from interfering with the latching protrusions 331 disposed in the innermost array when the line L is wound around the column portion 321. The line L can be more reliably fixed by the latching protrusions 331 that become higher toward the outer periphery of the fixing member 301.

Depending on the use environment, the user may merely insert and fix the line L to the fixing member 301 in a straight line shape as shown in FIG. 9. Alternatively, the line L may be inserted and fixed to the fixing member 301 by turning the line L at least once in one direction as shown in FIG. 10. Although not shown, a plurality of lines L may be inserted and fixed to the fixing member 301 at the same time.

While the present disclosure has been described above using the preferred embodiments, the scope of the present disclosure is not limited to the specific embodiments described above. A person having ordinary knowledge in the relevant technical field will be able to replace or modify the constituent elements. Such replacement or modification should be construed to fall within the scope of the present disclosure.

What is claimed is:

1. A line fixing device, comprising:
a first housing;
a second housing disposed to face the first housing; and
a fixing member at least partially provided between the first housing and the second housing and configured to hold and fix a line,
wherein the fixing member includes a base portion, a column portion, protruding from a center of the base portion, around which the line is to be wound, and a plurality of latching protrusions disposed at predetermined intervals along an outer periphery of the base portion and configured to hold and fix a portion of the line that is not wound around the column portion.

2. The line fixing device of claim 1, wherein a bent portion bent in a “C”-like shape is formed in an end portion of the fixing member, and the first housing is fitted to the bent portion of the fixing member.

3. The line fixing device of claim 1, wherein the fixing member is made of at least one of a silicon material, a urethane material and a rubber material.

4. The line fixing device of claim 1, wherein the latching protrusions are disposed in a plurality of arrays spaced apart at predetermined intervals between the column portion and an edge of the base portion, the latching protrusions disposed in the outermost array have a height greater than that of the latching protrusions disposed in the innermost array, and the latching protrusions disposed in a middle array between the outermost array and the innermost array have a height smaller than that of the latching protrusions disposed in the outermost array and greater than that of the latching protrusions disposed in the innermost array.

5. The line fixing device of claim 1, further comprising:
a first adhesive member attached to a lower surface of the first housing; and
a second adhesive member attached to a lower surface of the second housing.

6. The line fixing device of claim 1, wherein the latching protrusions have a tapered shape.

7. The line fixing device of claim 6, wherein the latching protrusions have a diameter gradually decreasing away from the base portion.

8. A line fixing device, comprising:
a first housing;
a second housing disposed to face the first housing; and
a fixing member at least partially provided between the first housing and the second housing and configured to hold and fix a line,
wherein the fixing member includes a base portion, a column portion, protruding from a center of the base portion, around which the line is to be wound, and a plurality of latching protrusions disposed at predetermined intervals along an outer periphery of the base portion and configured to hold and fix a portion of the line that is not wound around the column portion,
wherein the latching protrusions are disposed in a plurality of arrays spaced apart at predetermined intervals between the column portion and an edge of the base portion, the latching protrusions disposed in the outermost array have a height greater than that of the latching protrusions disposed in the innermost array, and the latching protrusions disposed in a middle array between the outermost array and the innermost array have a height smaller than that of the latching protrusions disposed in the outermost array and greater than that of the latching protrusions disposed in the innermost array.

9. The line fixing device of claim 8, further comprising:
a first adhesive member attached to a lower surface of the first housing; and
a second adhesive member attached to a lower surface of the second housing.

10. The line fixing device of claim 8, wherein the latching protrusions have a tapered shape.

11. The line fixing device of claim 10, wherein the latching protrusions have a diameter gradually decreasing away from the base portion.
